(19) United States
(12) Patent Application Publication
(10) Pub. No.: US 2003/0159023 A1
(43) Pub. Date: Aug. 21, 2003

(54) Repeated instruction execution

(75) Inventors: Stephen Barlow, Cambridge (GB); Timothy Ramsdale, Cambridge (GB); Robert Swann, Cambrige (GB); Neil Bailey, Cambrige (GB); David Plowman, Saffron Walden (GB)

Correspondence Address: SUGHRUE MION, PLLC, 2100 Pennsylvania Avenue, NW, Washington, DC, 20037-3212, US

(73) Assignee: ALPHAMOSAIC LIMITED

(21) Appl. No.: 10/284,165

(22) Filed: Oct. 31, 2002

(30) Foreign Application Priority Data
Oct. 31, 2001 (GB) 0126132.0

(51) Int. Cl. G06F 9/44; G06F 9/00

(52) U.S. Cl. 712/241

(57) ABSTRACT

A processing unit comprising: an execution unit for executing an operation defined by an instruction on a pair of input values; a repeat control unit for causing said operation to be repeatedly executed on successive pairs of values, wherein each repeated execution generates an output value; wherein the instruction includes a repeat indicator, which indicates the number of times the operation is to be executed for that instruction and a condition, the repeat control unit being operable in response to said repeat indicator to determine the number of times the operation is executed by the execution unit, and to cease repeated execution on detection that the output value no longer satisfies said condition whether or not the operation has been executed said number of times.

The present invention relates to repeated instruction execution in a processor.

It is increasingly the case that processors are being purpose built to fulfil the requirements of particular applications. The present invention concerns particularly, but not exclusively, a processor architecture for use in image processing or other multi-media applications.

Existing processor architectures use differing combinations of so-called scalar units and vector units. In the following, a scalar unit implies a unit capable of executing instructions defining a single operand set, that is, typically operating on a pair of source values and generating a destination value for each instruction. A vector unit operates in parallel on a plurality of value pairs to generate a plurality of results. The source values are often provided in the form of packed operands, that is two packed operands provide a plurality of value pairs, one from each operand in respective lanes.

In any type of processor, it is very often the case that the same instruction needs to be executed repeatedly, often on different input values. To achieve this, some instructions include a repeat indication which causes the instruction to be repeatedly executed.

It is an aim of this invention to provide for such repeated execution in a simple and flexible fashion.

According to one aspect of the present invention there is provided a processing unit comprising: an execution unit for executing an operation defined by an instruction on a pair of input values; a repeat control unit for causing said operation to be repeatedly executed on successive pairs of values, wherein each repeated execution generates an output value; wherein the instruction includes a repeat indicator, which indicates the number of times the operation is to be executed for that instruction and a condition, the repeat control unit being operable in response to said repeat indicator to determine the number of times the operation is executed by the execution unit, and to cease repeated execution on detection that the output value no longer satisfies said condition whether or not the operation has been executed said number of times.

Another aspect of the invention provides a vector processing unit for executing vector instructions, each instruction defining multiple value pairs, an operation to be executed and a repeat indicator, the vector processing system comprising a plurality of parallel processing units, each processing unit having an execution unit for executing the operation defined in the instruction on a pair of input values and for generating a result; a repeat control unit for causing said operation to be repeatedly executed on successive pairs of values; a scalar result unit connected to receive the results from the parallel processing units and to generate a final output value on each repeated execution; wherein the instruction includes a repeat indicator which indicates the number of times the operation is to be executed for that instruction and a condition, the repeat control unit being operable in response to said repeat indicator to determine the number of times the operation is executed by the execution unit, and to cease repeated execution on detection that the output value satisfies said condition whether or not the operation has been executed said number of times.

A further aspect of the invention provides a method of executing instructions in a vector processing unit, the method comprising: supplying to each of a plurality of processing units a respective pair of values on which an operation is to be implemented to generate a result: reading at each processing unit a repeat indicator supplied with said instructions the repeat indicator determining the number of times the operation is to be implemented; supplying the result to a scalar result unit which operates on said results to generate a final output value; and implementing the operation for the number of times determined by the repeat indicator while the final output value meets a condition defined in said instructions.

Another aspect of the invention provides a computer program comprising an instruction stream including vector instructions, each vector instruction defining multiple value pairs, an operation to be executed on each value pair, a repeat indicator and a condition, the computer program being loadable into a processing unit and co-operable therewith to implement said operation for the number of times indicated by the repeat indicator on successive pairs of values for as long as the result of said execution of each repeated operation satisfies said condition.

A further aspect of the invention provides a processing unit comprising: an execution unit for executing an operation defined by an instruction on a pair of input values; a repeat control unit for causing said operation to be repeatedly executed on successive pairs of values; wherein the instruction includes a repeat indicator which indicates the number of times the operation is to be executed for that instruction, an address for accessing at least one of said pairs of values, and an auto-increment indicator associated with said address, the processing unit including a plurality of registers, wherein the size of the increment implemented by the auto-increment indicator is held in said register, whereby the address is incremented by an increment of that size on each repeated operation.

This aspect of the invention is particularly useful for image processing, where the size of the increment held in the register can define the width of the image.

The processing units can be selected depending on the condition of flags stored in each unit compared with a condition defined in an instruction.

In the embodiment which is described, the semantics of the vector instructions and scalar instructions are flexible enough that a vector instruction can define source values either in the vector unit, in the scalar unit or in a data memory. In each case, an auto-increment indicator in the vector instructions causes the address used to access the data values to be incremented on each repeat of the instruction. The auto-increment indicator can indicate a number of bytes by which the address is incremented (“+=rx”) (as defined above), or in other embodiments imply that that number is 1 (“++”). Moreover, the vector unit can return its results either back to the vector unit itself as a packed operand, or to the scalar unit, as a scalar result, or to both.

Each vector instruction can identify two source packed operands, each operand containing a plurality of values in respective lanes. In the following, which describes a graphics processor, values are often referred to therein as pixels, because they represent the same.

An important advantage of the “repeat-while” instruction is that many signal or image processing applications perform calculations that repeat until some threshold condition is reached. The conventional repeat instruction requires additional instructions at each stage to test the condition in question, whereas the “repeat-while” instruction discussed herein renders such instructions unnecessary and is thus more efficient.

For a better understanding of the present invention, and to show how the same may be carried into effect, reference will now be made by way of example to the accompanying drawings, in which:

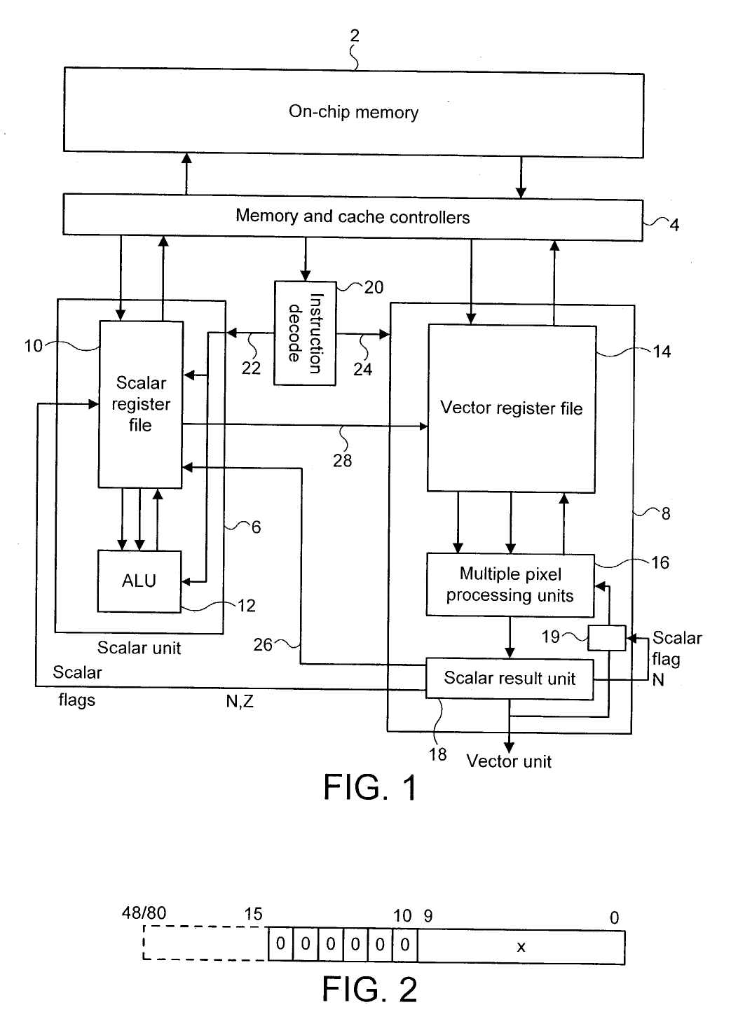

FIG. 1 is a schematic block diagram of the processor architecture;

FIG. 2 illustrates bits 0 to 15 of a vector instruction:

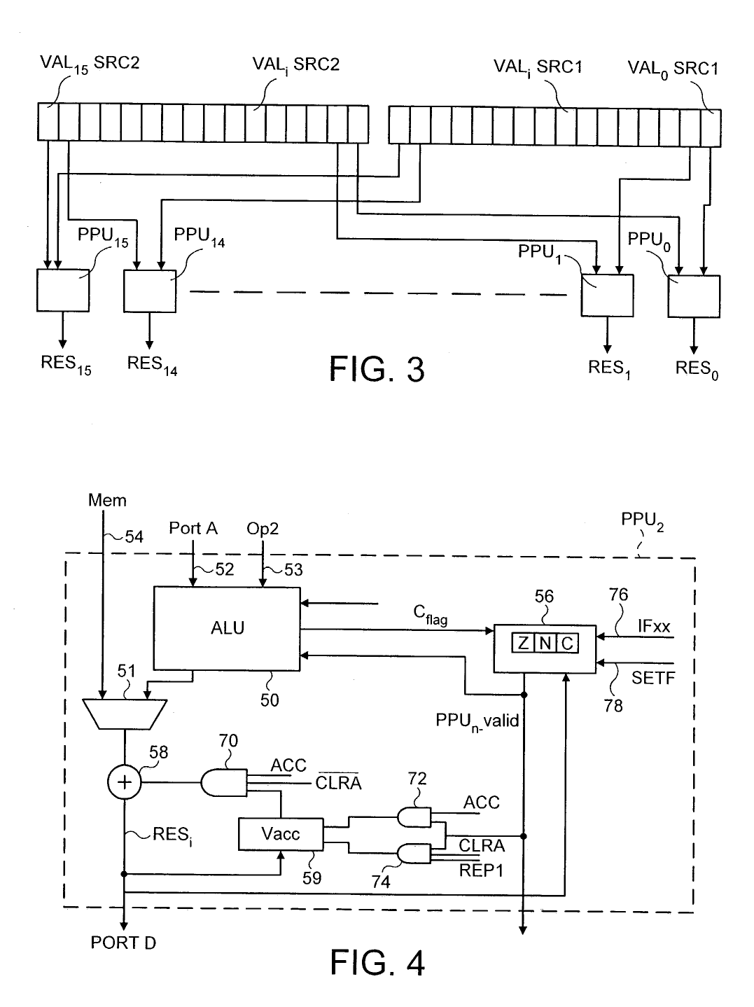

FIG. 3 is a schematic diagram illustrating parallel operation of multiple pixel processing units in the vector unit;

FIG. 4 is a schematic diagram illustrating the internal circuitry of pixel processing units; and

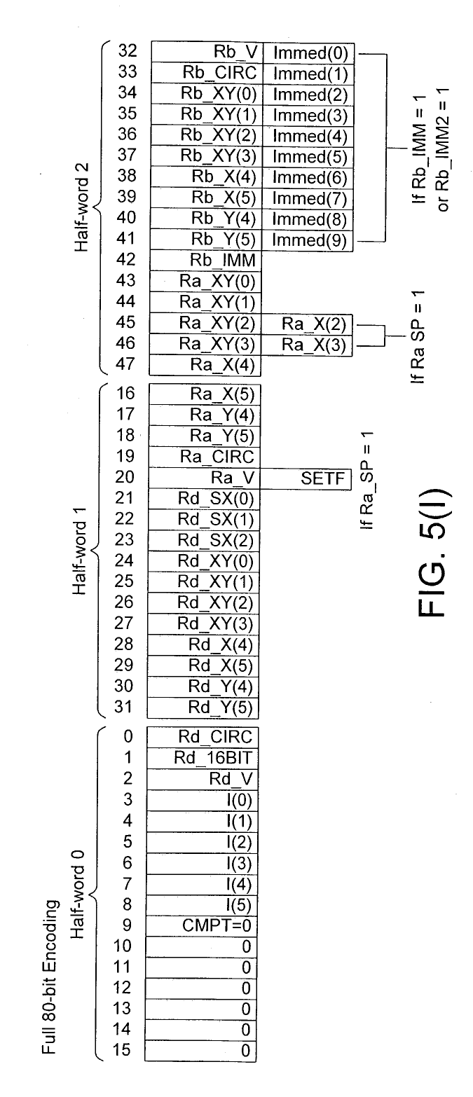

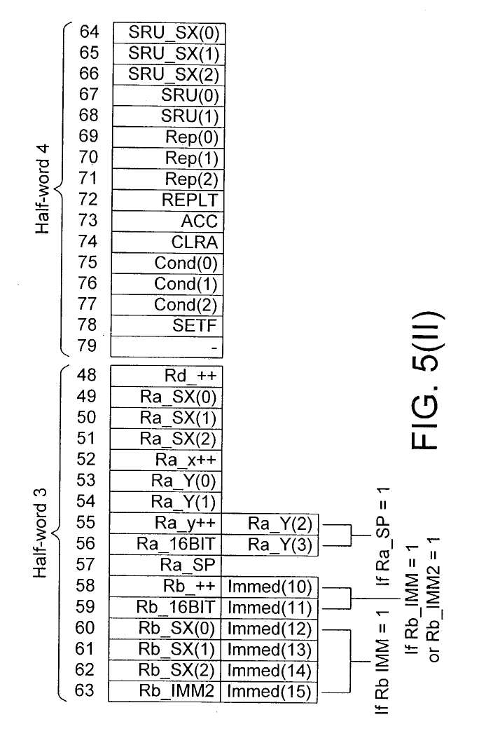

FIG. 5 illustrates 80-bit encodings of vector instruction.

FIG. 1 is a schematic block diagram of a processor in accordance with one embodiment of the invention. An on-chip memory 2 holds instructions and data for operation of the processor. Memory and cache controllers denoted generally by a block 4 control communication of instructions and data from the on-chip memory with the two main processing units of the processor. The first main processing unit 6 is a scalar unit and the second main processing unit 8 is a vector unit. The construction and operation of these units will be described in more detail in the following. In brief, the scalar unit 6 comprises a scalar register file 10 and an ALU processing block 12. The-vector unit 8 comprises a vector register file 14, a plurality of pixel processing units (PPU) denoted generally by a block 16, scalar result unit 18 and a repeat control unit 19. An instruction decoder 20 receives a stream of instructions from the on-chip memory 2 via the memory and cache controllers 4. The instruction stream comprises distinct scalar and vector instructions which are sorted by the instruction decoder 20 and supplied along respective instruction paths 22, 24 to the scalar unit and to the vector unit depending on the instruction encoding. The results generated by the vector unit, in particular in the scalar result unit 18, are available to the scalar register file as denoted by arrow 26. The contents of the scalar register file are available to the vector register file as indicated diagrammatically by arrow 28. The mechanism by which this takes place is discussed later.

FIG. 1 is a schematic view only, as will be apparent from the more detailed discussion which follows. In particular, the processor includes an instruction cache and a data cache which are not shown in FIG. 1 but which are shown in subsequent figures.

Before discussing the detail of the processor architecture, the principles by which it operates will be explained.

The scalar and vector units 6, 8 share a single instruction space with distinct scalar and vector instruction encodings. This allows both units to share a single instruction pipeline, effectively residing in the instruction decoder 20 (implemented as a control and instruction decode module). Instructions are dispatched sequentially to either the scalar unit 6 or to the vector unit 8, depending on their encodings, where they run to completion as single atomic units. That is, the control and instruction decode module 20 waits for the previous instruction to complete before issuing a new instruction, even if the relevant unit is available to execute the new instruction.

The scalar unit 6 and vector unit 8 operate independently. However, communication between the two units is available because of the following two facets of the processor architecture. Both units can read and write data in the main on-chip memory 2. In addition, the vector unit can use registers in the register file 10 as immediate values, indices into the vector register value, or addresses and offsets into main memory. The result of a vector operation in the vector unit 8 can then be written back into one of these scalar registers from the scalar result unit 18.

As a practical matter, the instruction decode unit decodes the incoming instruction and sets a large number of control lines according to the instruction received. These control lines spread throughout the rest of the chip. Some of them feed into the scalar unit (some (23) to the scalar register file, some (25) to the scalar ALU). These lines are used when the instruction received was a scalar one.

Other lines feed into the vector unit 8 along path 24. These are distributed so that some lines feed to the vector register file 14, some to the PPUs 16 and so forth. These are used when the instruction was a vector one. In the case of the PPUs, there are six control lines feeding identically from the instruction decode unit 20 into each of the 16 PPUs. In fact, these lines are set directly from the “opcode bits” in the vector instruction (discussed later).

Each PPU will individually examine these six control lines and perform a single operation on its inputs according to the current setting. Each of the 64 possible settings represents a single specific instruction (though not all are currently used).

A similar arrangement exists for the scalar ALU. When a scalar instruction is received, the instruction decode unit finds the correct “opcode bits” in the instruction and passes them along the control lines that run to the scalar ALU.

The scalar unit is not germane to the present invention and will not be discussed further herein in any detail. Suffice it to say it receives scalar results from the vector unit and can store and process such results by using its scalar register file. It is noted that one of the registers in the scalar register file 10 constitutes the program counter which points to the address of the current instruction and thus is used to control instruction fetches. The scalar instruction set uses a standard encoding of 16 bits, with 32 bit and 48 bit variants to cater for large immediate and offset values.

FIG. 2 illustrates bits 0 to 16 of a vector instruction. Of particular importance, it is to be noted that the 6 bit sequence 000000 in bits 10 to 15 of the instruction indicate that the instruction is not a scalar instruction but is in fact a vector instruction. This allows the instruction decoder 20 to distinguish between scalar instructions and vector instructions. Vector instructions are described in more detail later.

The vector unit 8 comprises sixteen 16 bit pixel processing units PPU₀ . . . PPU₁₅ which operate in parallel on two sets of sixteen values. These sets of values can be returned as packed operands from the vector register file 14, from the scalar register file 10 or from the main memory 2. The results of the PPU operations are handled as described later.

The detail of the vector register file 14 is not germane to the present invention and therefore is not described in detail herein. However, it is to be noted that groups of sixteen contiguous pixels are written or read at once, each pixel value being represented by an 8-bit or a 16-bit sequence.

As illustrated in FIG. 3, each pixel processing unit PPUi acts on two values. When the processor is a graphics processor, each value relates to a pixel. The vector instructions supply two operands to the pixel processing unit. These are labelled SRC1, denoting a first packed operand and SRC2, denoting a second packed operand in FIG. 3. Each operand comprises a plurality of values, in the described embodiment sixteen 16-bit values. A value from each operand is supplied to each pixel processing unit 16, such that PPUi operates on the ith element of the 16 element factors (operands) that have been processed simultaneously. An individual result is generated by each pixel processing unit, the result being labelled RESi in FIG. 3. A PPU can be selected or not selected depending on the states of internal flags 56 discussed later and a condition specified in a vector instruction.

The pixel processing units PPU₀ . . . PPU₁₅ will now be described with reference to FIG. 4. Each of the pixel processing units contains an ALU 50 which operates on two input 16-bit values VAL; SRC1, VAL; SRC2 supplied along two of three input paths 52, 53, 54 depending on their origin, to port MEM, to port A and port Op2 to create a single output value RESi, according to the operation that has been selected by the vector instruction. A multiplexer 57 selects two of the three input paths. Each pixel processing unit 16 has Z, N and C flags denoted generally by the flag block 56. The Z flag denotes a zero flag, the N flag denotes a negative flag and the C flag is a carry flag. The state of these flags can be used to define a condition which can be compared with a condition defined in a vector instruction to select or deselect an individual PPU. Each pixel processing unit includes an adder 58 and an accumulator 59, which allow the result of the ALU operation to be accumulated and then returned. The thus accumulated value is denoted V_{acc}. The output of each pixel processing unit 16 is supplied at port D to the vector register file and to the scalar result unit 18. In particular, the values that emerge from the PPUs are in essence always fed both back to the VRF and to the SRU. There are just a few qualifications, including the possibility that the destination register of a vector instruction may be given as “−” meaning “do not write the result back”. In this case, no values are returned to the VRF. The values are still passed on to the SRU as usual, however. In essence, there are two “destinations”, one for results from the PPUs 16 and one for results from the SRU 18.

Each pixel processing unit PPUi also includes three AND gates 70, 72, 74. These AND gates receive accumulate ACC, clear CLRA, and repeat REPn inputs respectively, the function of which is described in more detail later. These inputs are derived from modifiers contained in the vector instructions. Other instruction modifiers IFxx, SETF, are supplied to flag block 56 along paths 76, 78 respectively. Once again, the function of these modifiers will be discussed later.

The scalar result unit 18 operates on the outputs of the selected pixel processing units 16, that is those selected where the condition defined by the flags matches the condition defined in the instruction, depending on the operation defined in the vector instruction supplied to the vector unit. This value is then written back to the scalar register file 10 in the scalar unit 6 and the scalar flags N, Z are updated according to it.

Values can be supplied to the pixel processing units 16 in a number of different ways. The use of a 12 bit index from the SRF 10 creates an address into the vector register file. This causes data held in the vector register file to be supplied to the pixel processing units 16 into port A along path 52. Data for port Op2 can also be accessed from the vector register file using an index from the SRF 10 which has created an address.

An alternative supply of data to the pixel processing unit 16 is directly from on-chip memory 2. Such data is supplied to port MEM of the pixel processing unit.

From this discussion it will be appreciated that the input labelled 54 in FIG. 4 to the pixel processing units can supply either values from the vector register file, values from the scalar register file or values directly from memory to the ALU.

With a small number of exceptions, almost all vector instructions have a general three operand form:

<operation> R(yd,xd), R(ya,xa), Op2 [ <modifiers>]

where <operation> is the name of the operation to be performed, and registers in the vector register file are generically denoted R(y,x) due to the addressing semantics of the vector register file (discussed briefly later). In the above example R(yd,xd) is the destination register, R(ya,xa) is the first source register and Op2 may indicate a second source register R(yb,xb), or a value taken from one of the scalar registers of the SRF 10 or an immediate value (these latter two being repeated identically across all sixteen PPUs), as explained above. Finally <modifiers>are selected from an optional list of instruction modifiers which control how the PPUs 16 and the scalar result unit handle the results of the ALU operations in each PPU. The invention is particularly concerned with a repeat modifier, but the following description also discusses other modifiers which affect the PPUs and modifiers which affect the scalar result unit.

The instruction modifier which forms the basis of this invention is the so-called “repeat count modifier”, REPn. This allows instructions to be repeated a given number of times, optionally selecting a different input pair of values upon each repetition. The repeat count modifier takes the form REPn which indicates that the given instruction is to be performed n times. n must be one of 2, 4, 8, 16, 32, 48 or 64. The differences between writing out an instruction n times in the original program and using the modifier REPn are:

The clear accumulator modifier CLRA is applied only at the start of the initial repetition.

Auto-increment addressing (indicated by “++”) can be used to add one byte automatically to a y or x register offset upon each repetition, thus allowing differing sets of data values to be applied to the pixel processing units 16 on each repetition of the instruction. Load/store instructions also support auto-increment addressing using a given scalar register to compute a new memory address on each cycle, using “+=rx” The effect of auto-incrementing can be seen later with respect to examples of the various vector instruction types.

If the set flag modifier SETF (discussed below) and repeat modifier REP are included together, then the flags are updated at each repetition. If the instruction also includes a condition modifier Ifxx (discussed below), the set of active pixel processing unit 16 can change on every cycle of repetition.

A variant of the repeat modifier is the “repeat while less than” modifier REPLTn. This modifier is identical to the repeat modifier except that the repetition only continues while the result is negative (determined by the scalar flag N). The result is defined as the value produced by the scalar result unit 18. The modifier works in conjunction with the scalar result unit 18 which writes a value into a given scalar register on each repetition, thereby causing the scalar flags to be modified. The scalar flags are tested at the end of the instruction, meaning that there is always at least one repetition.

The “repeat” and “repeat while less than” modifiers are read by the repeat control unit 19 which supplies control signals to the PPUs as follows. The repeat control unit 19 receives the value of n from the instruction decode unit 20 and upon each repetition it decreases the value by 1. It feeds a control signal into the PPUs which indicates whether the instruction is still repeating or not. For the REPLT modifier it takes account of the scalar N flag, terminating the repetitions if that is no longer set.

A control signal Rep1 is supplied into AND gate 74 which is set only for the first repetition of an instruction, and cleared for all subsequent repetitions. This is the mechanism whereby the CLRA modifier only has an effect for the first repetition of the instruction.

As mentioned above, each pixel processing unit has a plurality of flags Z, N, C in block 59, which are settable and the state of which can be used to selectively control operation of the individual processing unit. The PPU flag modifiers exist in various of the vector instructions. The set of PPU flag modifiers is illustrated in Table 1 below.

TABLE I

| Modifier | Description |
|---|---|
| SETF | Update the PPU flags at the end of the operation |
| IFZ | Execute only if Z (zero) flag set |
| IFNZ | Execute only if Z flag not set |
| IFN | Execute only if N (negative) flag set |
| IFNN | Execute only if N flag not set |
| IFC | Execute only if C (carry) flag set |
| IFNC | Execute only if C flag not set |

IFXX

The term IFXX is used to refer collectively to all the modifiers above except SET F. The pixel processing unit 16 only performs the operation if the given condition, according to Table 1, is met. If the condition is not met, then the pixel processing unit is turned off. The ALU operation is not performed in that pixel processing unit, no saturation is performed, no accumulation takes place and no flags are changed in that pixel processing unit. Nor is the final pixel processing unit result written back to the destination register, the value formerly there being left unchanged.

SET F

If specified, the “Set Flag” modifier SETF causes each pixel processing unit 16 to update its flags at the end of the operation. The Z, N and C flags are updated according to the following rules:

The C flag is updated by the ALU operation and saturation unit.

The Z and N flags are set according to the final result of the pixel processing unit operation. This will be the output of the ALU if the accumulate modifier ACC was not present, or the accumulated value if it was.

The SETF and IFXX modifiers may be specified together. The set flags modifier SETF will only set the flags in those pixel processing units that match the IFXX condition.

Another modifier affecting the PPU is the “accumulate” modifier ACC. This modifier instructs the pixel processing unit 16 to add the result of the ALU operation to the current value of the accumulator 59. This addition is always performed using 16 bit signed saturating arithmetic. When the “accumulate” modifier ACC is specified, then the accumulated value, not the output of the ALU, becomes the final output read by the pixel processing unit. This means that the accumulated value will be written back to the destination register at port D.

The “clear accumulator” modifier CLRA instructs the pixel processing unit to set the accumulator value to zero at the start of the instruction. On a repeated instruction, CLRA is the only modifier which acts differently on repetitions after the first—it does nothing, such that the results of each repeated operation are accumulated in the PPUs.

The following examples exemplify use of the modifiers discussed above. In order to understand the following examples, it is necessary to give a brief description of the addressing semantics of the vector register file 8. The vector register file is set as an array of 8-bit pixel values. Sixteen contiguous 8-bit values are fetched on each access to the vector register file 8, each 8-bit value representing a pixel, and the register name giving the (y,x) coordinates of the top left pixel to be accessed. The letter H in the following exemplified instructions indicates that horizontally contiguous pixels are accessed.

### EXAMPLE 1

vadd H (0,0), H(0,0), #1

16 horizontally contiguous 8-bit pixels (“H”) are read from the top left (0,0) of the VRF. The PPUs add the immediate value 1 to each and the results are written back to the same location (only the least significant 8 bits are returned because the destination register is an 8-bit register). No flags are changed, and no accumulation occurs.

### EXAMPLE 2

vadd −, H(0,0), #0 SETF

vadd H(0,0), H(0,0), #1 IFN

These instructions process sixteen horizontally contiguous 8-bit values (“H”) located at (0,0) in the VRF. The first instruction sets the PPU flags according to the values there (but does not need to write the values back anywhere—hence “−” as the destination); the second instruction adds one only to the negative values (“IFN”), leaving the others alone.

[NB—I have changed example to avoid having to explain VRF addressing semantics.]

### EXAMPLE 3

vadd H(0++, 16), H(0++, 0), #0 REP 16

The 16×16 block of 8-bit pixels at (0,0) in the VRF is copied to (0,16) (adding zero is being used here just to copy registers). The H indicates that we read and write 16 horizontally contiguous pixels from the VRF. Upon each of the 16 repetitions (“REP 16”), the x-component of the source and destination are each incremented by 1 (“++”), that is 1 byte.

[NB—ditto]

### EXAMPLE 4

vdist−, H(0++,0), H(0++,16) REP 16 CLRA ACC SUM r0

Computes the distance (absolute difference) between two 16×16 pixel blocks. Each repetition computes the 16 distances between two sets of 16 values and each PPU adds the answer to its own accumulator (“ACC”), which also means these accumulated values become the PPU outputs. Finally we sum these 16 values and write the result, now the total distance between the two blocks, into scalar register r0 (“SUM r0”). The CLRA modifier clears the accumulators on the initial repetition, and is the only modifier to behave differently on subsequent repetitions (on which it does nothing).

### EXAMPLE 5

vsub−, H(0++,0)+r0, r1 REP 16

A constant value taken from register r1 (in the SRF) is subtracted from every pixel in an arbitrary 16×16 block. The scalar register r0 (in the SRF) supplies the address of the top left corner of the block to be processed. When used in this way, the 6 least significant bits of r0 indicate the x-offset of the block, and the next 6 bits indicate the y-offset.

The vector instructions operate on the pixel processing unit 16 in the following way.

Each of the sixteen pixel processing units is presented with two 16-bit values, one derived from R(ya,xa) and one derived from Op2. (Note that if 8-bit values are read from the vector register file then these are zero extended into 16-bit values.)

Each selected pixel processing unit performs its operation in accordance with the nature of the operation defined in the instruction. The operation is executed by the ALU 50. If an instruction modifier specifies accumulation of the results, then this takes place. In this case the accumulated values are returned as the final output values of the pixel processing units 16, otherwise the output of the ALU operation is returned as the final output of the pixel processing unit. The scalar result unit 18 performs any calculations indicated by modifiers. The scalar result unit operates on the final outputs from selected pixel processing units 16 and the result may be written to one of the scalar registers of the SRF 10 and the scalar flags will be set accordingly. The final outputs of the pixel processing units are also written back to the vector register file at port D.

The vector instruction set can be thought of as being constituted by four types of instructions:

load/store instructions

move instruction

data processing instructions

look up instructions.

It is to be noted that in writing the program, all vector instructions are preceded by v to denote that they are vector instructions. In the encoding, bits 10 to 15 are set to zero so that the fact that they are vector instructions can be recognised by the instruction decoder. Each instruction type has an 80-bit full encoding, and the more common ones have a compact 48-bit encoding. By way of example, FIG. 5 illustrates the 80-bit encodings for data processing instructions of the following form including REPn and REPLT modifier bits.

<operation> R(yd,xd),R(ya,xa),Op2.

Note that all instructions contain six bits to hold opcode, identifying the nature of the instruction (bits 3 to 8 of Half—Word 0, labelled l[0] to l[5]. These bits are supplied to each of the PPUs 16. Also note that bit 9 labelled CMPT is a flag which is set to one to indicate a compact 48-bit encoding and zero to indicate the full 80-bit encoding. The REP modifier bits are bits 69 to 72 of Half Word 4 in the 80b encoding.

The main categories of vector instructions are discussed below.

Load/Store Instructions

Vid R(yd,xd), (rx+#immediate+=rx2)

Load sixteen consecutive bytes or sixteen bit half words from memory into the vector register file.

The load instructions identify a destination register in the vector register file and identify a source operand by virtue of its address in main memory. Its address in main memory is calculated from the content of a register rx in the scalar register file 10 using the address calculation logic 64B and the resulting operand is supplied to port MEM.

The auto increment +=rx2 is used in conjunction with the repeat modifier REPn. On each repeat, the number of bytes specified in register rx₂ is added to the address value.

The store instructions identify a set of operands in the vector register file and cause them to be stored back to memory at an address identified using the contents of a scalar register. The instruction has the following format:

Vst R(ya,xa), (rx+#immediate+=rx₂).

Store sixteen consecutive bytes or half words from the VRF back to memory. The memory address is calculated using the address calculation logic 64_{B} as before.

The auto increment is used as before. The register rX₂ contains a number of bytes, which are added to the address value.

In both cases, if R(y,x) denotes an 8-bit register, sixteen bytes are stored. If R(y,x) denotes a 16-bit register, half words are stored.

Move Instructions

vmov R(yd,xd), Op2

moves OP2 to R(yd,xd).

In this case, Op2 may be a value from a scalar register rx, or an immediate value or an immediate value plus the value from a scalar register rx, or a VRF register R(yb,xb). In this case therefore there are a number of options for identifying the location of the source value, the destination location being identified in the vector register file.

Data Processing Instructions

All these instructions take the usual form:

<operation>R(yd,xd) R(ya,xa) Op2.

A number of different operations can be specified, including addition, subtraction, maximum, minimum, multiply, etc.

Look-up instructions are specialised instructions having the form:

vlookup R (yd,xd)

and are not discussed further herein. They allow access to the vector register file, the addressing semantics of which are not discussed further herein. As mentioned above, the scalar result unit 18 can implement different operations as defined by modifiers in the vector instructions.

On each repetition, the SRU 18 calculates a 32-bit value from the 16 PPU outputs and writes this result back to one of the scalar registers in the SRF 10 denoted by rx. The scalar unit N and Z flags are both updated by this process, with the C and V flags left unaffected. The modifiers that apply to the SRU are given in Table II.

TABLE II

| Modifier | Description |
|---|---|
| PPU0 rx | Place the output of PPU₀ into register rx |
| SUM rx | Sum all PPU outputs and place the result in rx |
| IMIN rx | Place the index (0 . . . 15) of the minimum PPU output in rx |
| IMAX rx | Place the index (0 . . . 15) of the maximum PPU output in rx |

PPU0

The output of the first PPU (PPU₀) is placed into scalar register rx, and the scalar flags updated accordingly. If, by virtue of conditional execution, PPU₀ is not operating, then the result is always zero.

SUM

All selected PPUs are summed and the result placed in rx, updating the scalar flags accordingly. If no PPUs are selected, then the result is always zero.

IMIN

The index i (running from 0 to 15) of PPUᵢ that contains the minimum value of any selected PPUs is placed in rx, and the scalar flags updated. If no PPUs are selected, then the result is −1. If two or more PPUs share the same minimum, the lowest valued index is returned.

IMAX

The index i of PPUᵢ that contains the maximum value of any selected PPUs is placed in rx, and the scalar flags updated. If no PPUs are selected, then the result is −1. If two or more PPUs share the same maximum, the highest valued index is returned.

None of these SRU modifiers can be mixed with one another.

1. A processing unit comprising:
an execution unit for executing an operation defined by an instruction on a pair of input values;
a repeat control unit for causing said operation to be repeatedly executed on successive pairs of values, wherein each repeated execution generates an output value;
wherein the instruction includes a repeat indicator, which indicates the number of times the operation is to be executed for that instruction and a condition, the repeat control unit being operable in response to said repeat indicator to determine the number of times the operation is executed by the execution unit, and to cease repeated execution on detection that the output value no longer satisfies said condition whether or not the operation has been executed said number of times.

2. A processing unit according to claim 1, in which the execution unit is an ALU.

3. A processing unit according to claim 1 or 2, wherein each instruction defines an address for accessing at least one of said pair of values, the instruction including an auto-increment indicator associated with said address, whereby the address is incremented on each-repeated operation.

4. A processing unit according to claim 3, comprising a plurality of registers, wherein the size of the increment is held in a said register indicated in the auto-increment indicator.

5. A processing unit according to any preceding claim, which comprises a plurality of flags, said flags defining a condition under which the processing unit is selected for operation if that condition matches a condition defined in a modifier which forms part of the instruction being executed.

6. A processing unit according to claim 5, wherein at least some of said instructions include a set flag modifier, which updates at least one of said flags in the processing unit.

7. A vector processing unit for executing vector instructions, each instruction defining multiple value pairs, an operation to be executed and a repeat indicator, the vector processing system comprising a plurality of parallel processing units, each processing unit having an execution unit for executing the operation defined in the instruction on a pair of input values and for generating a result;
a repeat control unit for causing said operation to be repeatedly executed on successive pairs of values;
a scalar result unit connected to receive the results from the parallel processing units and to generate a final output value on each repeated execution;
wherein the instruction includes a repeat indicator which indicates the number of times the operation is to be executed for that instruction and a condition, the repeat control unit being operable in response to said repeat indicator to determine the number of times the operation is executed by the execution unit, and to cease repeated execution on detection that the output value satisfies said condition whether or not the operation has been executed said number of times.

8. A vector processing unit according to claim 7, wherein said condition is that the value is negative.

9. A vector system according to claim 7 or 8, which includes a vector register file holding packed operands, each operand comprising multiple values.

10. A vector processing system according to any of claims 7 to 9, wherein each parallel processing unit comprises an accumulator which is selectively operable to accumulate the results for operations of the parallel processing unit.

11. A vector processing system according to claim 10, wherein at least some of said vector instructions define an accumulate modifier, which causes the accumulator to accumulate the results of successive operations of the parallel processing unit.

12. A method of executing instructions in a vector processing unit, the method comprising:
supplying to each of a plurality of processing units a respective pair of values on which an operation is to be implemented to generate a result;
reading at each processing unit a repeat indicator supplied with said instructions the repeat indicator determining the number of times the operation is to be implemented;
supplying the result to a scalar result unit which operates on said results to generate a final output value; and
implementing the operation for the number of times determined by the repeat indicator while the final output value meets a condition defined in said instructions.

13. A method according to claim 12, wherein the condition is at the final output value is negative.

14. A computer program comprising an instruction stream including vector instructions, each vector instruction defining multiple value pairs, an operation to be executed on each value pair, a repeat indicator and a condition, the computer program being loadable into a processing unit and co-operable therewith to implement said operation for the number of times indicated by the repeat indicator on successive, pairs of values for as long as the result of said execution of each repeated operation satisfies said condition.

15. A processing unit comprising:
an execution unit for executing an operation defined by an instruction on a pair of input values;
a repeat control unit for causing said operation to be repeatedly executed on successive pairs of values;
wherein the instruction includes a repeat indicator which indicates the number of times the operation is to be executed for that instruction, an address for accessing at least one of said pairs of values, and an auto-increment indicator associated with said address,
the processing unit including a plurality of registers, wherein the size of the increment implemented by the auto-increment indicator is held in said register, whereby the address is incremented by an increment of that size on each repeated operation.
